(19) United States
(12) Patent Application Publication
(10) Pub. No.: US 2014/0028526 A1
(43) Pub. Date: Jan. 30, 2014

(54) DUAL BAND PATCH ANTENNA

(71) Applicant: Pro Brand International, Inc., Marietta, GA (US)

(72) Inventors: GAVIN JAMES COX, Haslingden (GB); Hsu Yu-Chia, Hsinchu City (TW); Chen Kai-Hao, Hemei Township (TW)

(73) Assignee: Pro Brand International, Inc., Marietta, GA (US)

(21) Appl. No.: 13/951,154

(22) Filed: Jul. 25, 2013

Related U.S. Application Data
(60) Provisional application No. 61/676,111, filed on Jul. 26, 2012.

(51) Int. Cl. H01Q 5/00

(52) U.S. Cl. CPC H01Q 5/0027
USPC 343/893; 343/895; 29/600

(57) ABSTRACT

The present disclosure provides a dual band antenna. In one embodiment, the dual band antenna includes providing a trapezoidal monopole portion, wherein the trapezoidal monopole portion for operating in a low frequency range, a spiral portion coupled to the trapezoidal monopole portion, wherein the spiral portion for operating at a high frequency range, wherein the trapezoidal monopole portion and the spiral portion operate in multiple bands of a mobile communications network and a coaxial connection coupled to the trapezoidal monopole portion for communicatively coupling to a router.

### CROSS REFERENCE TO RELATED APPLICATIONS

This application claims priority under 35 U.S.C. §119(e) to U.S. provisional patent application Ser. No. 61/676,111, filed on Jul. 26, 2012, which is hereby incorporated by reference in its entirety.

### BACKGROUND

Currently, existing routers and modems for 4G wireless signals may not be optimally located at a given location, for example, indoors within a home. As a result, the wireless communication within the home may be spotty or inconsistent in various locations within the home. Currently, there are no external antennas that can be connected to existing 4G routers to improve the wireless performance of the existing routers.

Repeaters are available to carry a signal to various locations. However, repeaters simply re-broadcast and amplify the signal that is received by the router. As a result, if the incoming signal is weak the same weak signal will be received by the router. The repeater will not improve the quality of the incoming signal received by the router.

### SUMMARY

The present disclosure relates generally to a dual band antenna. In one embodiment, the dual band antenna comprises providing a trapezoidal monopole portion, wherein the trapezoidal monopole portion for operating in a low frequency range, a spiral portion coupled to the trapezoidal monopole portion, wherein the spiral portion for operating at a high frequency range, wherein the trapezoidal monopole portion and the spiral portion operate in multiple bands of a mobile communications network and a coaxial connection coupled to the trapezoidal monopole portion for communicatively coupling to a router.

The present disclosure also provides an external antenna for a long term evolution (LTE) router communicating with a mobile communications network. In one embodiment, external antenna comprises a printed circuit board, a first dual band antenna traced in the printed circuit board via a metal, a second dual band antenna traced in the printed circuit board via the metal reflectively positioned opposite the first dual band antenna and a housing. The first dual band antenna comprises a first trapezoidal monopole portion, wherein the first trapezoidal monopole portion for operating in a low frequency range, a first spiral portion coupled to the first trapezoidal monopole portion, wherein the first spiral portion for operating at a high frequency range, wherein the first trapezoidal monopole portion and the first spiral portion operate in multiple bands of the mobile communications network and a first coaxial connection coupled to the first trapezoidal monopole portion for communicatively coupling to the LTE router. The second dual band antenna comprises a second trapezoidal monopole portion, wherein the second trapezoidal monopole portion for operating in the low frequency range, a second spiral portion coupled to the trapezoidal monopole portion, wherein the second spiral portion for operating at the high frequency range, wherein the second trapezoidal monopole portion and the second spiral portion operate in multiple bands of the mobile communications network and a second coaxial connection coupled to the second trapezoidal monopole portion for communicatively coupling to the LTE router.

The present disclosure also provides a method for producing an external antenna for a long term evolution (LTE) router communicating with a mobile communications network. In one embodiment, the method comprises providing a printed circuit board, tracing a first dual band antenna in the printed circuit board via a metal, the first dual band antenna comprising a first trapezoidal monopole portion, wherein the first trapezoidal monopole for operating in a low frequency range, a first spiral portion coupled to the first trapezoidal monopole portion, wherein the first spiral portion for operating at a high frequency range, wherein the first trapezoidal monopole portion and the first spiral portion operate in multiple bands of the mobile communications network and a first coaxial connection coupled to the first trapezoidal monopole portion for communicatively coupling to the LTE router, tracing a second dual band antenna in the printed circuit board via the metal reflectively opposite the first dual band antenna, the second dual band antenna comprising a second trapezoidal monopole portion, wherein the second trapezoidal monopole portion for operating in the low frequency range, a second spiral portion coupled to the second trapezoidal monopole portion, wherein the second spiral portion for operating at the high frequency range, wherein the second trapezoidal monopole portion and the second spiral portion operate in multiple bands of the mobile communications network and a second coaxial connection coupled to the second trapezoidal monopole portion for communicatively coupling to the LTE router and enclosing the printed circuit board with a housing.

### BRIEF DESCRIPTION OF THE DRAWINGS

The teaching of the present disclosure can be readily understood by considering the following detailed description in conjunction with the accompanying drawings, in which:

FIG. 1 illustrates various views of a printed circuit board having two dual band antennas;

FIG. 2 illustrates one example of dimensions of a spiral portion of the dual band antenna;

FIG. 3 illustrates one example of dimensions of a trapezoidal monopole portion of the dual band antenna;

FIG. 4 illustrates one example of the external antenna with a housing in a communication network; and

FIG. 5 illustrates one example of a flowchart for a method for producing an external antenna.

To facilitate understanding, identical reference numerals have been used, where possible, to designate identical elements that are common to the figures.

### DETAILED DESCRIPTION

The present disclosure relates to a dual band patch antenna. Currently, existing routers and modems for wireless signals may not be optimally located at a given location, for example, indoors within a home. As a result, the wireless communication within the home may be spotty or inconsistent in various locations within the home. Currently, there are no external antennas that can be connected to existing 4G routers to improve the wireless performance of the existing routers.

One embodiment of the present disclosure provides a dual band patch antenna for 3G and long term evolution (LTE) communication networks that are part of the fourth generation (4G) of wireless/cellular communication networks. The dual band patch antenna may be externally connected to an existing router or modem. The dual band patch antenna may be connected to the existing router using a coaxial cable connection. The dual band patch antenna may have a relatively small form factor measuring within a few hundred millimeters in length and width and a few millimeters in thickness.

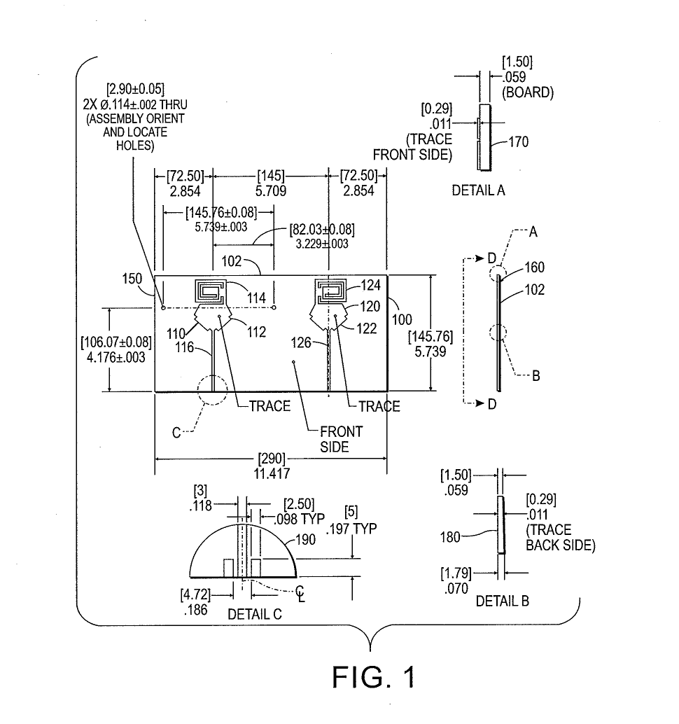

FIG. 1 illustrates various views of an external antenna 100. In one embodiment, the external antenna 100 may be remotely coupled to a router. For example, the external antenna 100 may be communicatively coupled to the router externally and remotely. Said another way, the external antenna 100 is not directly coupled to part of the router, such as the antennas that are part of the router itself, and can be positioned independently of the router location. The external antenna may be considered a separate “unit” from the router that requires a connection there between, e.g., a coaxial cable.

In one embodiment, a front view 150 shows the external antenna 100 comprising a printed circuit board 102 and a first dual band antenna 110 and a second dual band antenna 120. The front view 150 illustrates one example of dimensions of the printed circuit board 102. All measurements are illustrated in millimeters (mm) and inches in FIGS. 1-3.

In one embodiment, the dual band antennas 110 and 120 may each include a trapezoidal monopole portion 112 and 122, a spiral portion 114 and 124 and a coaxial connection 116 and 126, respectively. In one embodiment, the dual band antennas 110 and 120 may be designed and fabricated to operate in multiple bands, for example, bands 4 and 13. The dual band antennas may be fabricated to operate for multiple frequency ranges, for example, the trapezoidal monopole portions 112 and 122 may operate in the low frequency range (e.g., approximately 740 Megahertz (MHz)-790 MHz) within band 13. For example, the download frequency may be approximately 746 MHz-756 MHz and the upload frequency may be approximately 777 MHz-787 MHz. The spiral portions 114 and 124 may operate in the high frequency range (e.g., approximately 1700 MHz to 2200 MHz) within band 4. For example, the upload frequency may be approximately 1710-1755 MHz and the download frequency may be approximately 2110 MHz-2155MHz.

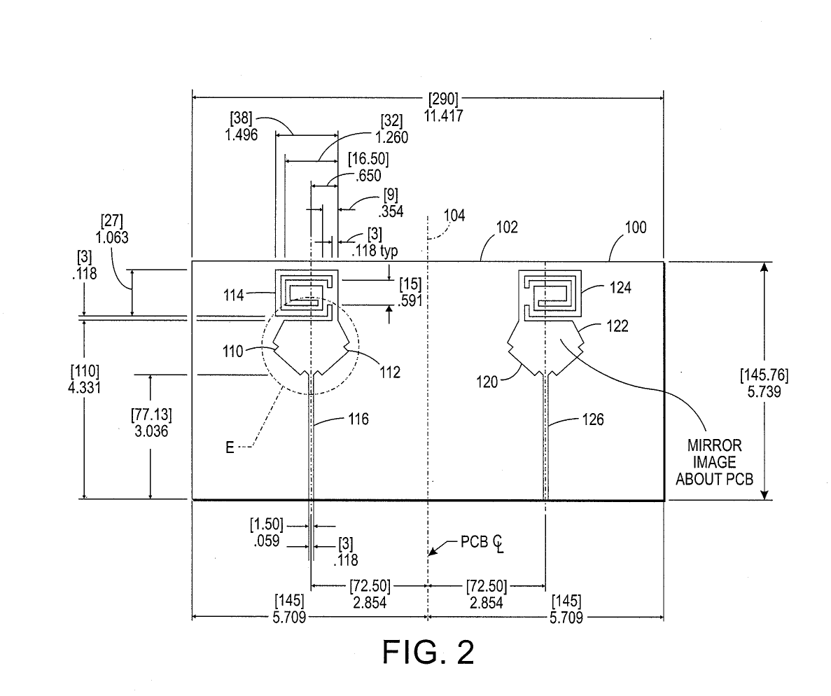

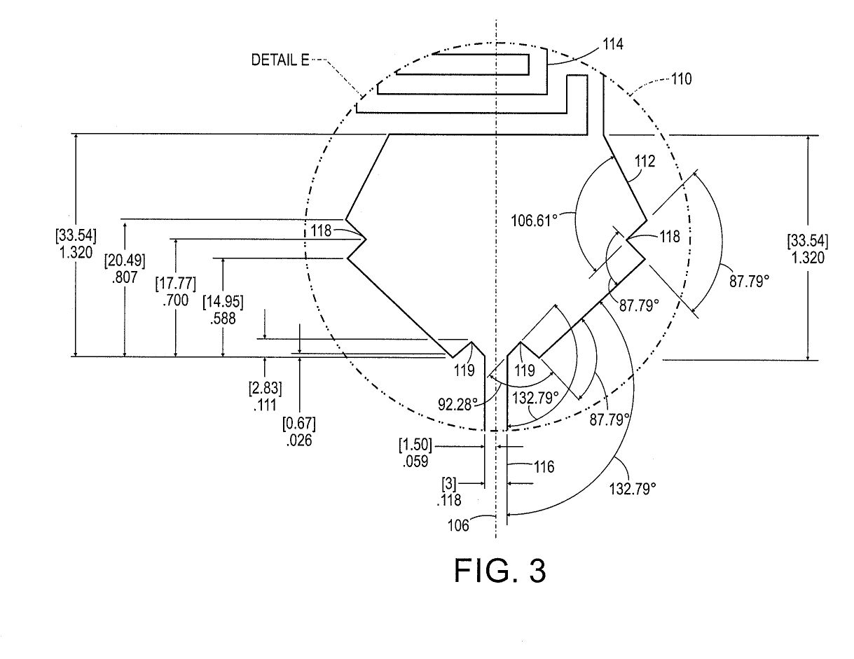

However, it should be noted that the dual band antennas may be designed to operate in other bands that are specific for other regions outside of the United States. For example, the dual band antennas may be designed to operate in bands and/or frequency ranges that are specific to Europe or Asia which have been allocated to 3G/4G communication. The specific dimensions of the trapezoidal monopole portions 112 and 122 and the spiral portions 114 and 124 illustrated in FIGS. 2 and 3 below are specific to embodiments for the above bands and frequency ranges.

In one embodiment, the dual band antennas 110 and 120 may be fabricated using any conductive material. In one embodiment, the dual band antennas are fabricated from copper.

In one embodiment, the dual band antennas 110 and 120 may be located on the printed circuit board 102 to optimize performance. In one embodiment, the dual band antennas 110 and 120 should be located for optimal correlation and diversity performance. For example, correlation should be minimized while diversity is maximized. In addition, multiple antennas may be used to provide multiple input multiple output (MIMO) performance to increase the bandwidth of the dual band antennas 110 and 120 in the 4G environment.

In one embodiment, the dual band antennas 110 and 120 are designed to be omnidirectional and radiate with equal power in all directions on the horizon. In one embodiment, the dual band antennas 110 and 120 may be designed such that the signal is vertically polarized.

In one embodiment, the dual band antennas 110 and 120 may be designed to have the coaxial connections or outputs 116 and 126. In other words, each one of the dual band antennas 110 and 120 may have a coaxial connection 116 and 126, respectively, to externally connect to a router or modem. For example, in a dual band antenna design, both dual band antennas 110 and 120 would be connected to the router using the coaxial connections 116 and 126, respectively.

In one embodiment, the printed circuit board 102 may be housed in a plastic casing. The housing can be either wall mounted or supplied with a stand. The dual band patch antenna housed in the plastic casing may be suitable for indoor or outdoor use.

A side view 160 of the printed circuit board 102 illustrates a point of reference for a detailed view of points A, B and D (illustrated in FIG. 2). The detailed view of point A 170 provides example measurements of a thickness or a width of the printed circuit board 102 and the trace of the dual band antennas 110 and 120. The detailed view of point B 180 provides example measurements of a thickness or a width of the printed circuit board 102 and a trace on a backside of the printed circuit board 102. The detailed view of point C 190 provides example measurements of a width of the coaxial connections 116 and 126.

As discussed above, the dual band antennas 110 and 120 may be designed for dual frequencies. FIG. 2 illustrates a more detailed view of point D shown in the side view 160. FIG. 2 illustrates a more detailed view of the spiral portion 114 of the dual band antenna 110 that operates in the higher frequencies. In addition, FIG. 2 illustrates various additional example dimensions such as, for example, a length from of the coaxial connection 116 from a bottom of the trapezoidal monopole portion 112 to a bottom edge of the printed circuit board 102, a length from a top of the trapezoidal monopole portion 112 to the bottom edge of the printed circuit board 102, and the like.

It should be noted that the dimensions can apply equally to the spiral portion 124 of the dual band antenna 120. For example, the dual band antenna 120 may be a mirror image of the dual band antenna 110 flipped along a center line 104. A mirror image may be defined as being identical in size and dimensions, but flipped in opposite directions. For example, the spiral portion 114 and the spiral portion 124 have identical dimensions, but the spiral portion 114 points to the left and the spiral portion 124 points to the right. In other words, the dual band antennas 110 and 120 are reflectively symmetric about the center line 104. However, the antenna would still work if the dual band antenna 110 were translated on the board such as the trace 116 aligned in the same position currently occupied by the trace 126. Said another way, translated may mean that the dual band antenna 110 may be positioned exactly on the same location and orientation as the dual band antenna 120.

In one embodiment, the spiral portions 114 and 124 of the dual band antennas 110 and 120 may be a square spiral design. However, it should be noted that the spiral may be in other shapes such as a circle, rectangle and the like, for a particular application, frequency range or band.

In one embodiment the spiral portions 114 and 124 comprise an inner loop 113 and 123, respectively and an outer loop 115 and 125, respectively. In one embodiment, the inner loops 113 and 123 may have a length of approximately 1.260 mm and a height of approximately 0.591 mm. In one embodiment, the outer loops 115 and 125 have a length of approximately 1.496 and a height of approximately 1.063 mm. FIG. 2 illustrates these dimensions by example as well as other specific dimensions of the spiral portions 114 and 124.

FIG. 3 illustrates a more detailed view of the trapezoidal monopole portion 112 of the dual band antenna 110. The dimensions and angles illustrated for the trapezoidal monopole portion 112 may equally apply to the trapezoidal monopole portion 122 of the dual band antenna 120.

In one embodiment, the trapezoidal monopole portion 112 may be a notched trapezoidal design. In one embodiment, the location and dimensions of notches 118 and 119 may be a function of the desired frequency range and performance. In one embodiment, the trapezoidal monopole portion 112 may include a pair of notches 118 and a pair of notches 119. The angles of the notches 118 and 119 and the dimensions are illustrated in FIG. 3. For example, FIG. 3 provides dimensions such as a vertical distance between the notches, how deep the notches are cut, how wide the notches are cut, and the like

In one embodiment, the notches 118 and 119 may comprise a triangle shaped notch. In one embodiment, the notch 118 may be adjacent to the coaxial connection 116 and cut at an angle of approximately 92.21 degrees as illustrated in FIG. 3 in detail E. The second notch 119 may be located above the first notch and cut out of a corner of the trapezoidal monoₚole portion 112 at an angle of approximately 87.79 degrees as illustrated in FIG. 3 in detail E. FIG. 3 illustrates other specific angles with respect to various points of the trapezoidal monopole portion 112.

In one embodiment, the trapezoidal monopole portion 112 may be designed as a mirror image flipped along a center line 106. In other words, the trapezoidal monopole portion 112 may be symmetrical on both sides of the line 106. In other words, the notches 118 on both sides of the center line 106 have the same dimensions and angles and the notches 119 on both sides of the center line 106 have the same dimensions and angles. In another embodiment, the trapezoidal monopole portion 112 may be translated similar to the translation of the dual band antennas 110 and 120 discussed above.

In one embodiment, the design (e.g., the specific size and location of notches 118 and 119) and dimensions (e.g., the length, the thickness, the angles of each of the notches 118 and 119, the positioning of the trapezoidal monopole potions 112 and 122 relative to the spiral portions 114 and 124, and the like) of the trapezoidal monopole portions 112 and 122 and the spiral portions 114 and 124 may be a function of the desired frequency range and performance. FIGS. 2 and 3 illustrate examples of the specific dimensions for trapezoidal monopole portions 112 and 122 to operate in a frequency range of approximately 740 MHz-790 MHz and the spiral portions 114 and 124 to operate in a frequency range of approximately 1700-2200 MHz. It should be noted that the dimensions are designed for a specific frequency range and application and changing the example dimensions may change the performance and operational parameters of the dual band antennas 110 and 120. However, a manufacturing or engineering tolerance may be applied to the dimensions illustrated in FIGS. 2 and 3, while maintaining operation in bands 4 and 13 and in the frequency ranges of approximately 740 MHz-790 MHz and 1700-2200 MHz. Examples of the engineering tolerances are illustrated in FIG. 1.

As a result, the present disclosure provides a dual band patch antenna that may be externally attached to an existing router. The dual band patch antenna improves performance of existing routers and, specifically, for routers used in 4G LTE communication networks and the associated communication bands and frequencies.

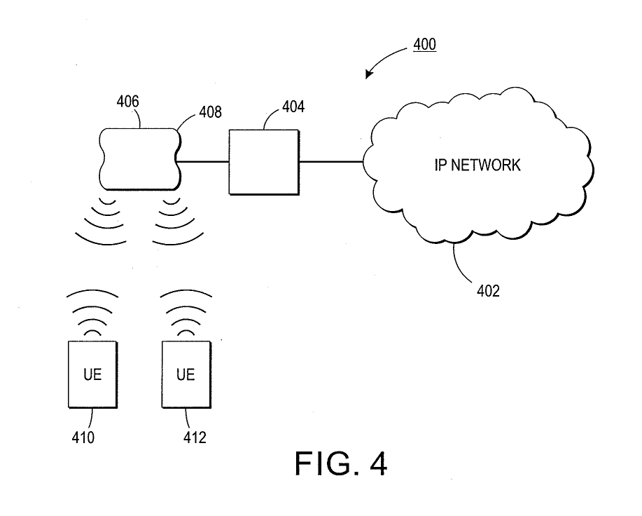

FIG. 4 illustrates an example communications network 400. In one embodiment, the communications network 400 may include an Internet Protocol (IP) or cellular network 402. For example, the network 402 may be a mobile communications network, e.g., a 3G or 4G LTE network. The network 402 may include one or more network elements such as radio towers, eNodeBs, gateways, border elements, and the like that are not shown.

In one embodiment, a router 404 may be in communication with the network 402. In one embodiment, the router 404 may be a router in the home, a personal mobile hotspot router, a HomeFusion Broadband (e.g., a Cantenna) product, and the like.

In one embodiment, an external antenna 406 may be coupled to the router 404. The external antenna 406 may include the external antenna 100 enclosed in a housing 408. As noted above, the external antenna 406 may be coupled to the router 404 via a coaxial connection using the coaxial connections 116 and 126 of the external antenna 100 and corresponding coaxial connections on the router 404.

In one embodiment, the external antenna 406 may be suitable for indoor or outdoor use. For example, the antenna 406 and the router 404 may be located inside of a home at a customer premises or may be located outdoors as a user travels with the personal mobile hotspot.

In one embodiment, the external antenna 406 may wirelessly communicate with one or more network infrastructure endpoints 410 and 412 over bands 4 and/or 13 and at frequency ranges of approximately 740 MHz-790 MHz and 1700-2200 MHz, as discussed above.

It should be noted that the external antenna 406 having the external antenna 100 is not simply a repeater. In other words, the external antenna 406 does not simply receive a signal from the router 404 and re-broadcast the signal. Rather, the external antenna 406 may be used to actually increase the primary receive signal and not simply re-broadcast the primary receive signal. In other words, the range may be extended by the ability to receive a weaker primary signal and not by re-broadcasting the signal from one repeater to the next until it reaches the endpoint.

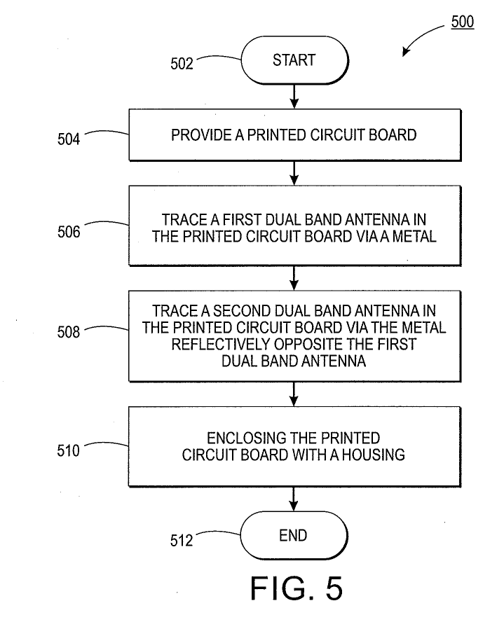

FIG. 5 illustrates a flowchart of a method 500 for producing an external antenna. In one embodiment, one or more steps or operations of the method 500 may be performed by a machine or a processor.

The method 500 begins at step 502. At step 504, the method 500 provides a printed circuit board.

At step 506, the method 500 traces a first dual band antenna in the printed circuit board via a metal. In one embodiment, the first dual band antenna may include a first trapezoidal monopole portion, a first spiral portion and a first coaxial connection. In one embodiment, the first spiral portion and the first coaxial connection may be coupled to the first trapezoidal monopole portion.

In one embodiment, the first dual band antenna may be designed to operate in bands 4 and 13 of a mobile communications network. In addition, the first dual band antenna may be designed to operate at frequency ranges of approximately 740 MHz-790 MHz and 1700-2200 MHz. For example, the first trapezoidal monopole portion may operate at the higher frequency range and the first spiral portion may operate at the lower frequency range.

At step 508, the method 500 traces a second dual band antenna in the printed circuit board via the metal reflectively opposite the first dual band antenna. In one embodiment, the second dual band antenna may include a second trapezoidal monopole portion, a second spiral portion and a second coaxial connection. In one embodiment, the second spiral portion and the second coaxial connection may be coupled to the second trapezoidal monopole portion.

In one embodiment, the dimensions of the second dual band antenna may be identical to that of the first dual band antenna. However, the second dual band antenna may be located as a mirror image of the first dual band antenna along an axis on the printed circuit board but could also undergo translation.

In one embodiment, the second dual band antenna may be designed to operate in bands 4 and 13 of a mobile communications network. In addition, the second dual band antenna may be designed to operate at frequency ranges of approximately 740 MHz-790 MHz and 1700-2200 MHz. For example, the second trapezoidal monopole portion may operate at the higher frequency range and the second spiral portion may operate at the lower frequency range.

At step 510, the method 500 encloses the printed circuit board with a housing. In one embodiment, the housing may include external connectors coupled to the coaxial connections to enable coupling of the external antenna to a router via a coaxial cable. In one embodiment, the housing may have a small form factor and be similar in size to the printed circuit board. At step 512, the method 500 ends.

It should be noted that although not explicitly specified, one or more steps, functions, or operations of the method 500 described above may include a storing, displaying and/or outputting step as required for a particular application. In other words, any data, records, fields, and/or intermediate results discussed in the methods can be stored, displayed, and/or outputted to another device as required for a particular application.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A dual band antenna, comprising:
a trapezoidal monopole portion, wherein the trapezoidal monopole portion is for operating in a low frequency range;
a spiral portion coupled to the trapezoidal monopole portion, wherein the spiral portion is for operating at a high frequency range, wherein the trapezoidal monopole portion and the spiral portion operate in multiple bands of a mobile communications network; and
a coaxial connection coupled to the trapezoidal monopole portion for communicatively coupling to a router.

2. The dual band antenna of claim 1, wherein the low frequency range comprises approximately 740 Megahertz (MHz)-790 MHz.

3. The dual band antenna of claim 1, wherein the high frequency range comprises approximately 1700 Megahertz (MHz)-2200 MHz.

4. The dual band antenna of claim 1, wherein the multiple bands comprise bands 4 and 13.

5. The dual band antenna of claim 1, wherein the spiral portion comprises a square spiral.

6. The dual band antenna of claim 1, wherein the dual band antenna comprises a metal traced onto a printed circuit board.

7. The dual band antenna of claim 1, wherein dimensions of the trapezoidal monopole portion comprise:
a first notch and a second notch on a first side of a center line; and
a third notch and a fourth notch on a second side that is symmetric of the center line, wherein the first notch and the third notch are symmetric and the second notch and the fourth notch are symmetric,
wherein the first notch is a triangular notch that is adjacent to the coaxial connection and cut at an angle of approximately 92.21 degrees,
wherein the second notch is a triangular notch that is cut out of a corner of the trapezoidal monopole portion above the first notch at an angle of approximately 87.79 degrees.

8. The dual band antenna of claim 1, wherein dimensions of the spiral portion comprise:
an inner loop, wherein the inner loop has a length of approximately 1.260 millimeters (mm) and a height of approximately 0.591 mm; and
an outer loop, wherein the outer loop has a length of approximately 1.496 mm and a height of approximately 1.063 mm.

9. An external antenna for a long term evolution (LTE) router communicating with a mobile communications network, comprising:
a printed circuit board;
a first dual band antenna traced in the printed circuit board via a metal, the first dual band antenna comprising:
a first trapezoidal monopole portion, wherein the first trapezoidal monopole portion is for operating in a low frequency range;
a first spiral portion coupled to the first trapezoidal monopole portion, wherein the first spiral portion is for operating at a high frequency range, wherein the first trapezoidal monopole portion and the first spiral portion operate in multiple bands of the mobile communications network; and
a first coaxial connection coupled to the first trapezoidal monopole portion for communicatively coupling to the LTE router;
a second dual band antenna traced in the printed circuit board via the metal reflectively positioned opposite the first dual band antenna, the second dual band antenna comprising:
a second trapezoidal monopole portion, wherein the second trapezoidal monopole portion is for operating in the low frequency range;
a second spiral portion coupled to the second trapezoidal monopole portion, wherein the second spiral portion is for operating at the high frequency range, wherein the second trapezoidal monopole portion and the second spiral portion operate in multiple bands of the mobile communications network; and
a second coaxial connection coupled to the second trapezoidal monopole portion for communicatively coupling to the LTE router; and
a housing enclosing the printed circuit board.

10. The external antenna of claim 9, wherein the low frequency range comprises approximately 740 Megahertz (MHz)-790 MHz.

11. The external antenna of claim 9, wherein the high frequency range comprises approximately 1700 Megahertz (MHz)-2200 MHz.

12. The external antenna of claim 9, wherein the multiple bands comprise bands 4 and 3.

13. The external antenna of claim 9, wherein the first spiral portion and the second spiral portion each comprises a square spiral.

14. The external antenna of claim 9, wherein the first dual band antenna and the second dual band antenna provide multiple input multiple output (MIMO) functionality.

15. The external antenna of claim 9, wherein the first dual band antenna and the second dual band antenna are positioned to minimize correlation and to maximize diversity.

16. The external antenna of claim 9, wherein the first dual band antenna and the second dual band antenna are each omnidirectional and each radiates power equally in all directions on a horizon.

17. The external antenna of claim 9, wherein the first dual band antenna and the second dual band antenna each vertically polarizes a signal.

18. The external antenna of claim 9, wherein dimensions of the first trapezoidal monopole portion and the second trapezoidal monopole portion each comprises:
a first notch and a second notch on a first side of a center line; and
a third notch and a fourth notch on a second side that is symmetric of the center line, wherein the first notch and the third notch are symmetric and the second notch and the fourth notch are symmetric,
wherein the first notch is a triangular notch that is adjacent to a respective coaxial connection and cut at an angle of approximately 92.21 degrees,
wherein the second notch is a triangular notch that is cut out of a corner of a respective trapezoidal monopole portion above the first notch at an angle of approximately 87.79 degrees.

19. The external antenna of claim 9, wherein dimensions of the first spiral portion and the second spiral portion each comprises:
an inner loop, wherein the inner loop has a length of approximately 1.260 millimeters (mm) and a height of approximately 0.591 mm; and
an outer loop, wherein the outer loop has a length of approximately 1.496 mm and a height of approximately 1.063 mm.

20. A method for producing an external antenna for a long term evolution (LTE) router communicating with a mobile communications network, comprising:
providing a printed circuit board;
tracing a first dual band antenna in the printed circuit board via a metal, the first dual band antenna comprising:
a first trapezoidal monopole portion, wherein the first trapezoidal monopole portion for operating in a low frequency range;
a first spiral portion coupled to the first trapezoidal monopole portion, wherein the first spiral portion for operating at a high frequency range, wherein the first trapezoidal monopole portion and the first spiral portion operate in multiple bands of the mobile communications network; and
a first coaxial connection coupled to the first trapezoidal monopole portion for communicatively coupling to the LTE router;
tracing a second dual band antenna in the printed circuit board via the metal reflectively opposite the first dual band antenna, the second dual band antenna comprising:
a second trapezoidal monopole portion, wherein the second trapezoidal monopole portion for operating in the low frequency range;
a second spiral portion coupled to the second trapezoidal monopole portion, wherein the second spiral portion for operating at the high frequency range, wherein the second trapezoidal monopole portion and the second spiral portion operate in multiple bands of the mobile communications network; and
a second coaxial connection coupled to the second trapezoidal monopole portion for communicatively coupling to the LTE router; and
enclosing the printed circuit board with a housing.
